(19) United States
(12) Patent Application Publication
(10) Pub. No.: US 2012/0204486 A1
(43) Pub. Date: Aug. 16, 2012

(54) Prefabricated gardening apparatus

(76) Inventor: Sarah Elizabeth Unruh, Brooklyn, NY (US)

(21) Appl. No.: 13/385,255

(22) Filed: Feb. 10, 2012

Related U.S. Application Data
(60) Provisional application No. 61/463,113, filed on Feb. 11, 2011.

(51) Int. Cl. A01G 1/00

(52) U.S. Cl. 47/33

(57) ABSTRACT

A gardening assembly apparatus having a modular flexible sheet of material with one or more top and bottom pre-cut slots on the flexible sheet of material. The slots may be used to connect parts of the flexible sheet of material in the assembly of the gardening assembly apparatus. Both top and bottom pre-cut slots may be positioned at certain predetermined lengths and/or reciprocally positioned in relation to one another along the length of the flexible sheet of material. The top and bottom pre-cut slots may be measured at half the height of the flexible sheet of material and may be configured to accommodate multiple connections which would allow for modular connections. The positions of the top and bottom slots, along with the numerous connections made, provide for a variety of gardening assembly apparatus configurations for each gardening application.

### CROSS REFERENCE TO RELATED APPLICATION(S)

This patent application claims priority to Provisional Patent Application Ser. No. 61/463,113 filed before the United States Patent & Trademark Office on Feb. 11, 2011 and entitled “Prefabricated system of raised garden beds”.

### FIELD OF THE INVENTION

The present invention is generally related to systems and apparatuses directed to gardening systems and planting gardening assembly apparatuses.

### BACKGROUND OF THE INVENTION

Current gardening systems rely on the availability of arable plots in order to develop gardens especially in urban areas. In areas where arable land is scarce, gardening is curtailed by this limitation. The problem is that there is a lack of viable products in the market which offer unique and creative solutions for building a raised garden bed. As such, there exists a need for a gardening system, gardening assembly apparatus or apparatus that enables gardening in urban areas, thereby enabling a more efficient use of space.

Efficient and effective garden beds, such as raised garden beds, provide an economical solution to both building a garden and making efficient use of limited space as the gardener could customize the shape and size of the garden. By containing the soil used to plant in a raised bed, the soil conditions can easily be controlled. Such a gardening assembly apparatus or system also allows for effective pest control and better drainage. The system/gardening assembly apparatus is also ideal for use in urban settings.

### SUMMARY OF THE INVENTION

In light of the foregoing problems it is an object of the present invention to disclose a gardening assembly apparatus that may be assembled by a gardener in a configuration that is both desired and fulfills the needs required.

It is an object of the present invention to provide a gardening assembly apparatus that may be a playful addition to the thriving “food gardening” market. It is also an object of the present invention to provide a gardening assembly apparatus/system that is configured for use on a level outdoor surface and can contain soil material for gardening.

The benefits of this invention are the flexibility the units provide in adapting to the wide variety of spaces. The unique design of connecting slots allow for endless expansion and a wide variety of configurations to accommodate different space conditions and limitations.

It is also an object of the present invention to provide a gardening assembly apparatus/system that is modular thereby allowing for the addition of extra units to increase gardening capacity. The gardening assembly apparatus/system may have one or more pre-cut slots for connecting to itself or additional modules.

It is another object of the present invention to provide a gardening assembly apparatus that may be fabricated using a rigid yet flexible material. As such, the gardening assembly apparatus may be made out of a variety of materials that are flexible such as high density polyethylene or polypropylene plastic. The invention may be adapted or configured for use on a flat surface and filled with planting material. The invention may also be adapted to allow for water drainage while retaining soil for planting. The invention may be further adapted to withstand normal outdoor conditions, rain, snow, wind. In one embodiment, the capacity of the gardening assembly apparatus/system may vary. In another embodiment the depth of the gardening assembly apparatus/system may be at least 10″ deep.

It is another object of the present invention to provide a gardening assembly apparatus that may consist of one unit that, without hardware or other tools, may be assembled by one individual or a child. It is another object of the present invention to provide a gardening assembly apparatus that may be modular in design to allow for more units to increase planting capacity and customize shape and configuration. The configurations are unique in the marketplace in shape and allow users many solutions for size and shape. The configurations are intended to bring “whimsy” to gardening and inspire creative planting schemes. In one aspect of an embodiment of the present invention, the final assembled configuration may be circular or parabolic in shape.

It is another object of the present invention to provide a gardening assembly apparatus that may be configured for use on a variety of surfaces including: porous or non-porous surfaces, paved or hard scraped surface, wood deck or patio surface, roof deck or roof garden, stone, ground or gravel surface, residential or public recreational facility; and use in all climate conditions. The invention may also be used to grow vegetable and herb plants, ornamental and decorative flowers and plants outdoors.

It is another object of the present invention to provide a gardening assembly apparatus that may hold soil for use in outdoor gardening.

It is another object of the present invention to provide a gardening assembly apparatus that that may comprise of a single piece of pre-cut polyethylene or polypropylene plastic that can be used alone or in combination with other units to create a self-contained raised garden bed. Each unit may be pre-slotted in a variety of configurations that enable the piece to stand on its own by joining to itself (via slots) and with other pieces in a wide variety of configurations. By joining a top slot to a bottom slot the piece creates an enclosed space or gardening enclosure to which garden soil materials are added for growing plants.

It is yet another object of the present invention to provide a gardening assembly apparatus that is made of flexible sheet of material where the flexible sheet of material has one or more pre-cut slots at the top of the material one or more pre-cut slot located at the bottom of the flexible sheet of material. In one embodiment, these pre-cut slots are used to connect parts of the flexible sheet of material in the assembly of the gardening assembly apparatus. The top and bottom pre-cut slots may be positioned at certain predetermined lengths along the flexible sheet of material. In addition, each of the one or more one top and bottom pre-cut slots is half the height of the flexible sheet of material. Further, each connection may be made by connecting a top slot with a bottom one.

It is yet another object of the present invention to provide a gardening assembly apparatus where the one or more top and bottom pre-cut slots are each able to accommodate a number of pre-cut slot connections, where the number of possible pre-cut slot connections is determined by the ratio between the width of either of the one or more top and bottom pre-cut slots and the thickness of the flexible sheet of material. As an example, where the width of the pre-cut slot is three times the thickness of the flexible material, then that slot would be able to accommodate three connections or three other pre-cut slots.

It is yet another object of the present invention to provide a gardening assembly apparatus where the flexible sheet of material has a height in the range of 10-12 inches, although additional embodiments may have different heights depending on the application or for use of the gardening assembly apparatus on a variety of surfaces.

It is yet another object of the present invention to provide a gardening assembly apparatus where the one or more top and bottom pre-cut slots are each configured to connect with additional flexible sheets of material by way of the pre-cut slots of the additional flexible sheets of material.

It is yet another object of the present invention to provide a gardening assembly apparatus where the gardening assembly apparatus is configured to allow for water drainage.

It is yet another object of the present invention to provide a gardening assembly apparatus the gardening assembly apparatus is modular in design.

It is yet another object of the present invention to provide a gardening assembly apparatus where the gardening assembly apparatus is configured for use on a variety of surfaces.

It is yet another object of the present invention to provide a gardening assembly apparatus where the one or more top and bottom pre-cut slots are positioned to create a variety of desired gardening enclosure shapes when the gardening assembly apparatus is fully assembled. In one aspect of an embodiment of the present invention, the pre-cut slots are located in spots that ensure that a circular gardening enclosure is formed when the gardening assembly apparatus is assembled. In another aspect, a parabolic shape may be formed as a result of the positioning of the pre-cut slots.

It is a further object of the present invention to provide a gardening assembly apparatus having a flexible sheet of material which in turn has one or more pairs of reciprocally positioned slots used to connect parts of the flexible sheet of material in the assembly of the gardening assembly apparatus. In one aspect of an embodiment of the present invention, the one or more pairs of reciprocally positioned slots are positioned at certain locations along the flexible sheet of material and each slot of the pair is half the height of the flexible sheet of material.

It is a further object of the present invention to provide a gardening assembly apparatus where each slot of the pair of reciprocally positioned slots is able to accommodate a number of pre-cut slot connections. In one aspect of an embodiment of the present invention, the number of pre-cut slot connections is determined by the ratio between the width of each slot and the thickness of the flexible sheet of material. For example, if the width of the slot is three times the thickness of the flexible sheet of material, then the slot would be able to accommodate three slot connections.

It is a further object of the present invention to provide a gardening assembly apparatus where each slot of the pair of reciprocally positioned slots is configured to connect with additional flexible sheets of material by way of the slots of the additional flexible sheets of material. This would enable the gardening assembly apparatus to increase the planting enclosures formed.

It is a further object of the present invention to provide a gardening assembly apparatus where the one or more pairs of reciprocally positioned slots are positioned to create a variety of desired gardening enclosure shapes when the gardening assembly apparatus is fully assembled.

### BRIEF DESCRIPTION OF THE DRAWINGS

The features and advantages of aspects of embodiments of the present invention will become more apparent from the detailed description set forth below when taken in conjunction with the claims and drawings, in which like reference numbers indicate identical or functionally similar elements. Additionally, the left-most digit of a reference number identifies the drawing in which the reference number first appears.

FIG. 1A illustrates a side view of gardening assembly apparatus 100 according to an exemplary aspect of the present invention.

FIGS. 1B through 1D illustrate steps of assembling gardening assembly apparatus 100 according to an exemplary aspect of the present invention.

FIG. 1E illustrates a perspective view of an exemplary assembled configuration of gardening assembly apparatus 100 according to an exemplary aspect of the present invention.

FIGS. 1F and 1G show plan views of two different assembly configurations of gardening assembly apparatus 100 according to exemplary aspects of the present invention.

FIG. 1H illustrates a perspective view of an exemplary assembled configuration of gardening assembly apparatus 100 showing one enclosure filled with dirt and with seedlings according to an exemplary aspect of the present invention.

FIG. 1I illustrates a side view of an exemplary assembled configuration of gardening assembly apparatus 100 showing both enclosures filled with dirt and with growing plants according to an exemplary aspect of the present invention.

FIG. 1J illustrates a perspective view of a gardening assembly apparatus 100 coiled up for storage according to an exemplary aspect of the present invention.

FIG. 2A illustrates a side view of a 2-piece gardening assembly apparatus 200 according to an exemplary aspect of the present invention.

FIG. 2B illustrates a partially assembled 2-piece gardening assembly apparatus 200 according to an exemplary aspect of the present invention.

FIG. 2C illustrates a fully assembled 2-piece gardening assembly apparatus 200 according to an exemplary aspect of the present invention.

FIG. 2D illustrates a plan view of a fully assembled 2-piece gardening assembly apparatus 200 showing one possible configuration according to an exemplary aspect of the present invention.

FIG. 2E illustrates a plan view of a fully assembled 2-piece gardening assembly apparatus 200 showing a different assembly configuration according to an exemplary aspect of the present invention.

FIG. 3A illustrates a side view of a 3-piece gardening assembly apparatus 300 according to an exemplary aspect of the present invention.

FIG. 3B illustrates a plan view of a fully assembled 3-piece gardening assembly apparatus 200 showing one possible configuration according to an exemplary aspect of the present invention.

FIG. 4A illustrates a side view of gardening assembly apparatus 400 having four slots according to an exemplary aspect of the present invention.

FIG. 5 illustrates a perspective view of a fully assembled gardening assembly 500 having multiple slots according to an exemplary aspect of the present invention.

### DETAILED DESCRIPTION OF THE DRAWINGS

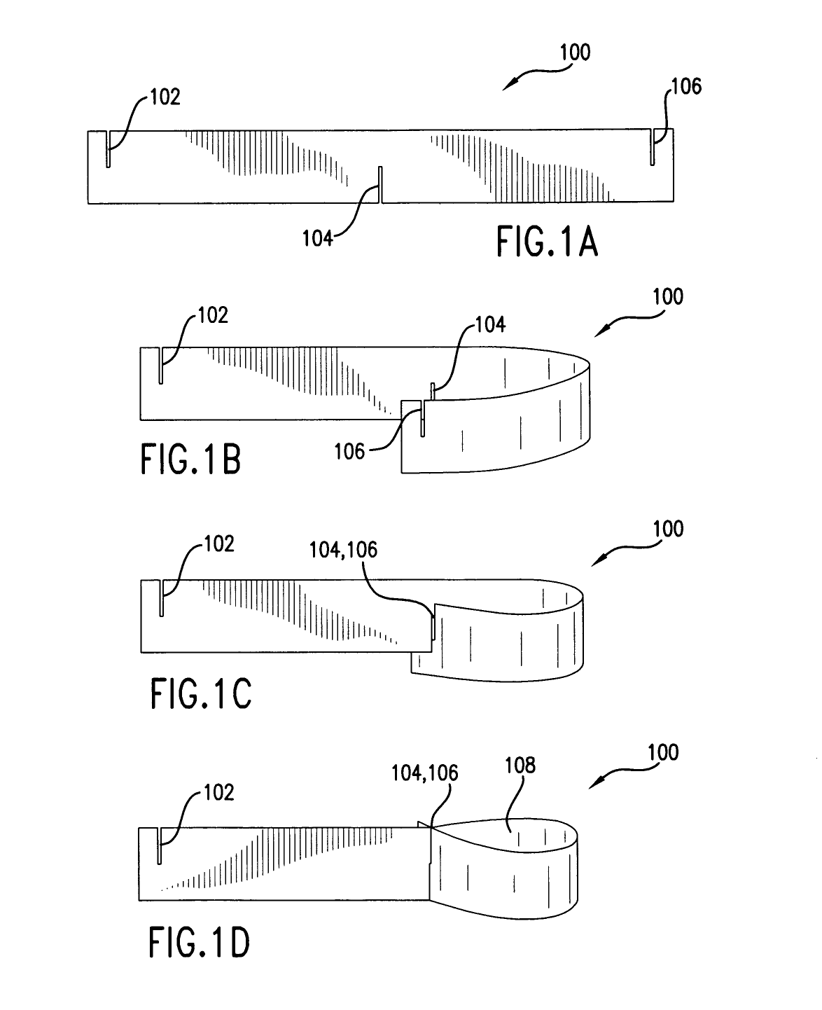

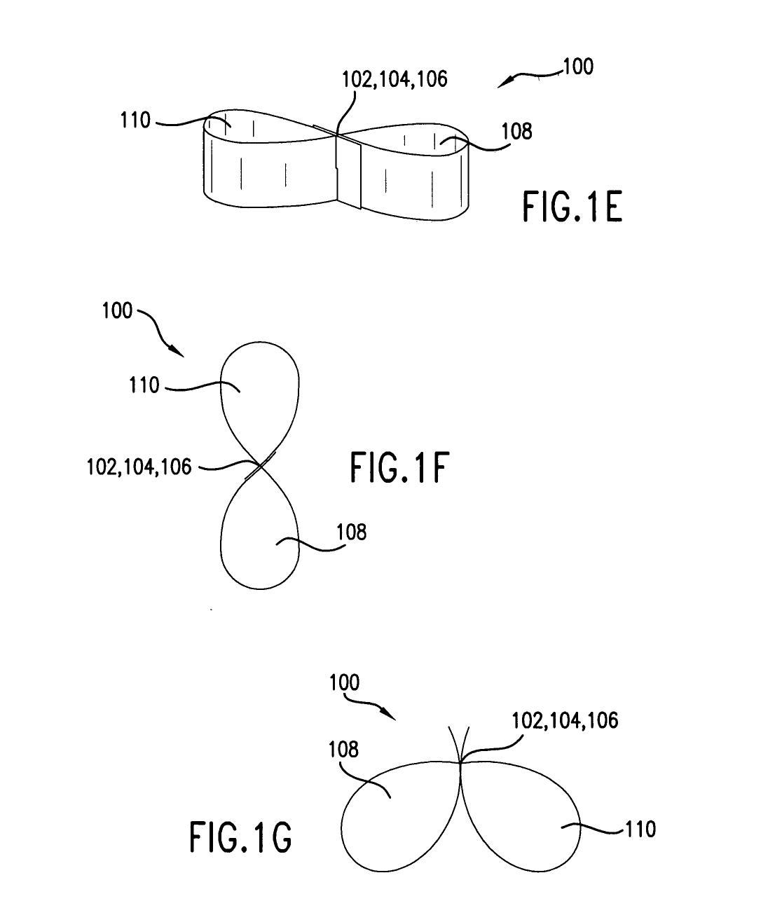

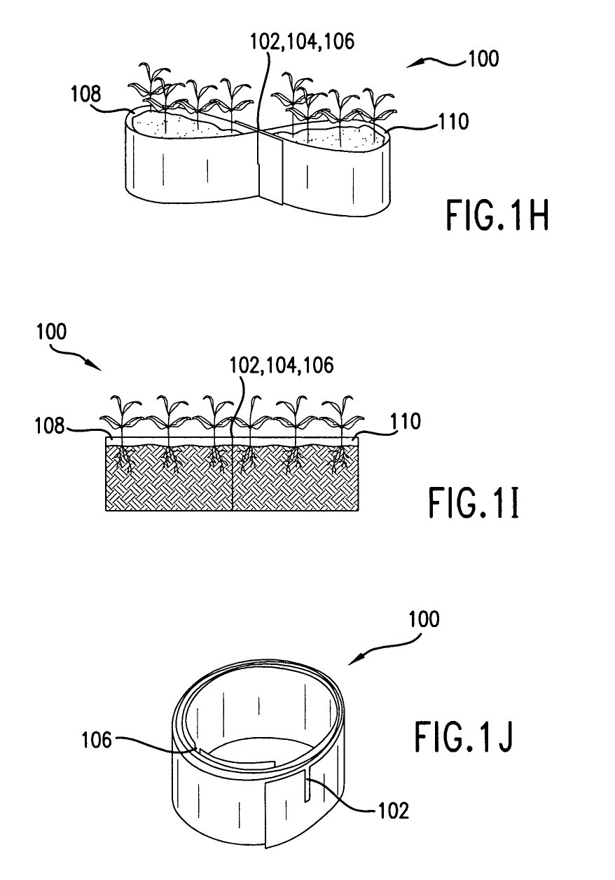

Referring now to FIG. 1A, a side view of gardening assembly apparatus 100 according to an exemplary aspect of the present invention is shown. Gardening assembly apparatus 100 is shown with slots 102, 104 and 106. Slots 102 and 106 are located at the top of gardening assembly apparatus 100 while slot 104 appears at the bottom half as shown. In one aspect of an embodiment of the present invention, each of slots 102, 104 and 106 are half the height of gardening assembly apparatus 100.

Referring now to FIGS. 1B through 1D the steps of assembling gardening assembly apparatus 100 according to an exemplary aspect of the present invention are shown. In this aspect, slot 106 is folded to be connected with slot 104. Once connected, they form gardening enclosure 108 which may then be filled with soil and have plants planted therein. The shape of gardening enclosure 108 may be determined by the distance between slots 104 and 106.

Referring now to FIG. 1E, a perspective view of an exemplary assembled configuration of gardening assembly apparatus 100 according to an exemplary aspect of the present invention is shown. Here, the assembly has been completed by connecting slot 102 with slots 104 and 106. The connection of slot 102 with slots 104 and 106 creates an additional enclosure, 110. Which may then be filled with soil and have plants planted within it. Similar to gardening enclosure 108, the shape of gardening enclosure 110 depends on the distance between slot 102 and slot 104.

Referring now to FIGS. 1F and 1G, plan views of two different assembly configurations of gardening assembly apparatus 100 according to an exemplary aspect of the present invention are shown. In FIG. 1F, the configuration so shown is formed by connecting slots 104, 106 with slot 102 being folded in one direction. The configuration so shown in FIG. 1G is formed by connecting slots 104, 106 with slot 102 being folded in a direction opposite to the direction taken in FIG. 1F. In both instances, gardening enclosures 108 and 110 are still formed.

Referring now to FIG. 1H, a perspective view of an exemplary assembled configuration of gardening assembly apparatus 100 assembled by connecting slots 102, 104 and 106 and showing one gardening enclosure 110 filled with dirt and with growing plants according to an exemplary aspect of the present invention, is shown.

Referring now to FIG. 1I, a side view of an exemplary assembled configuration of gardening assembly apparatus 100 assembled by connecting slots 102, 104 and 106 and showing both gardening enclosures 108 and 110 filled with dirt and with growing plants in gardening enclosure 108 according to an exemplary aspect of the present invention, is shown.

Referring now to FIG. 1J, a perspective view of a coiled up gardening assembly apparatus 100 according to an exemplary aspect of the present invention, is shown. Here, gardening assembly apparatus 100 is not being used, has slots 102, 104 and 106 disconnected from one another and may be coiled as shown for storage.

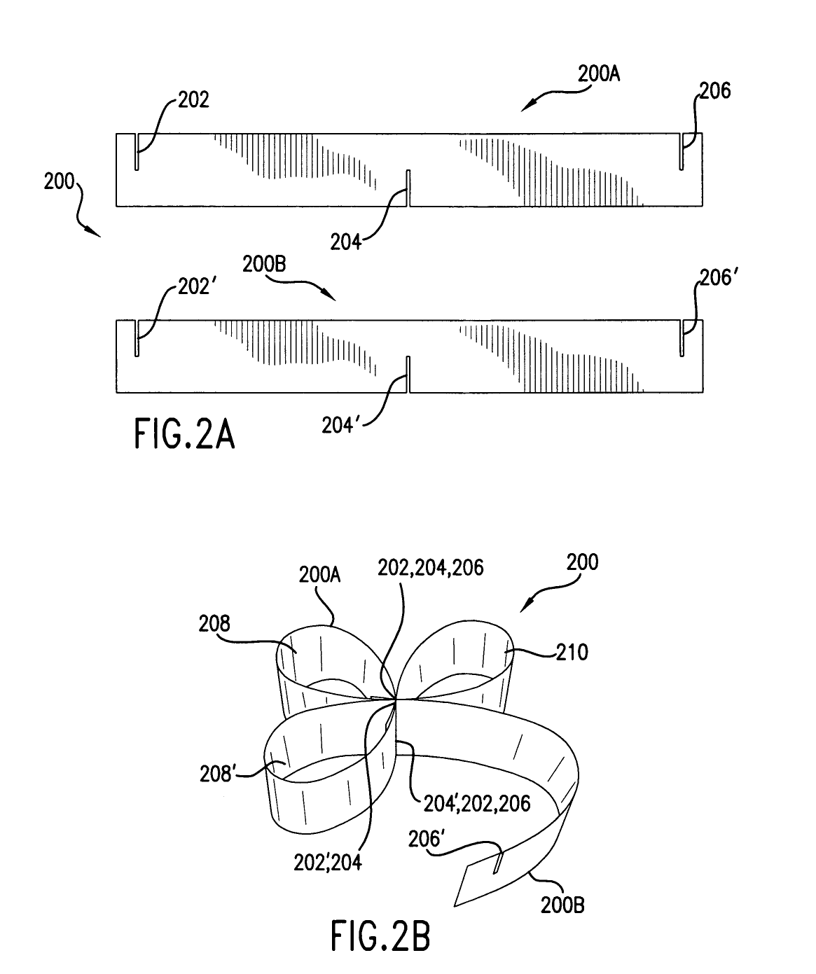

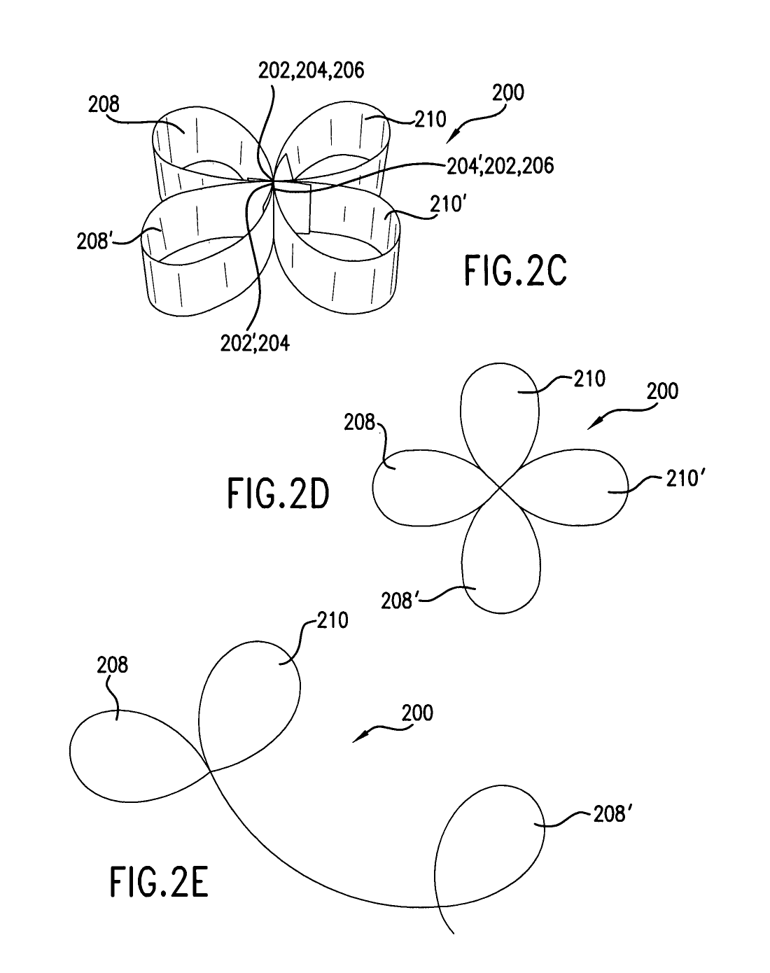

Referring now to FIGS. 2A through 2C, side and perspective views of a 2-piece gardening assembly apparatus 200 according to exemplary aspects of the present invention are shown. 2-piece gardening assembly apparatus 200 comprises of first gardening assembly apparatus 200A having slots 202, 204 and 206 and second gardening assembly apparatus 200B having slots 202′, 204′ and 206′. In one aspect of an embodiment of the present invention, gardening enclosures 208 and 210 are formed by connecting slots 202 and 206 of first gardening assembly apparatus 200A with slot 204 also of first gardening assembly apparatus 200A. In one aspect of an embodiment of the present invention, gardening enclosure 208′ is formed by connecting slot 202′ of second gardening assembly apparatus 202B with slot 204 of first gardening assembly apparatus 200A and connecting slot 204′ of second gardening assembly apparatus 200B with slots 202 and 206 of first gardening assembly apparatus 200A. In one aspect of an embodiment of the present invention, gardening enclosure 210′ is then formed by connecting slots 206′ and 204′ both of second gardening assembly apparatus 200B.

Referring now to FIG. 2D, a plan view of a fully assembled 2-piece gardening assembly apparatus 200 showing one possible configuration according to an exemplary aspect of the present invention, is shown. The 2-piece gardening assembly apparatus 200 is shown with gardening enclosures 208, 208′, 210 and 210′ which may then be used to plant seedlings or plants. This is one possible configuration as others may be made possible using different connections as illustrated in FIG. 2E, which shows a plan view of a fully assembled 2-piece gardening assembly apparatus 200 using a different assembly configuration according to an exemplary aspect of the present invention.

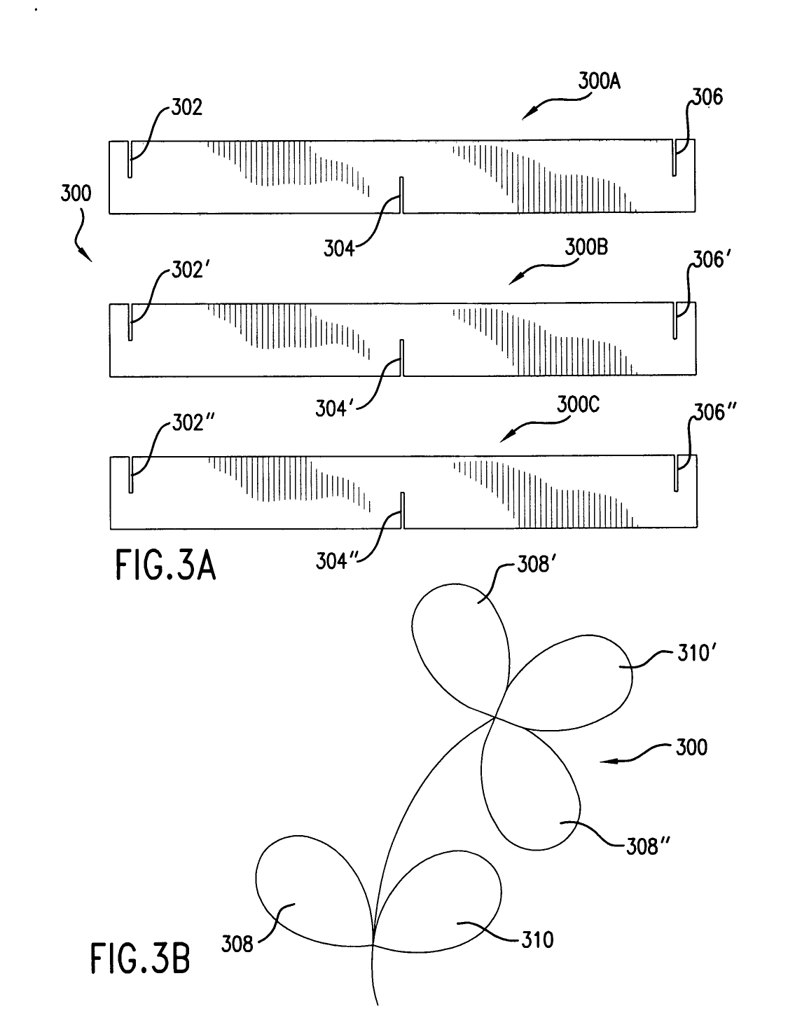

Referring now to FIG. 3A, a side view of a 3-piece gardening assembly apparatus 300 according to an exemplary aspect of the present invention, is shown. 3-piece gardening assembly apparatus 300 comprises of first gardening assembly apparatus 300A having slots 302, 304 and 306, second gardening assembly apparatus 300B having slots 302′, 304′ and 306′ and third gardening assembly apparatus 300C having slots 302″, 304″ and 306″.

FIG. 3B, a plan view of a fully assembled 3-piece gardening assembly apparatus 300 showing one possible configuration according to an exemplary aspect of the present invention, and showing gardening enclosures 308, 308′, 308″, 310 and 310′. In one aspect of an embodiment of the present invention gardening enclosure 308 and 310 may be formed by connecting slots 302 and 306 of first gardening assembly apparatus 300A with slot 304, also of first gardening assembly apparatus 300A. In one aspect of an embodiment of the present invention, gardening enclosures 308′ and 310′ may be formed by connecting slots 302′ and 306′ of second gardening assembly apparatus 300B with slot 304 also of second gardening assembly 300B. the fully assembled 3-piece gardening assembly apparatus 300 may be formed by connecting slots 302 and 306 with slot 304 (all of first gardening assembly apparatus 300A), connecting slot 302′ (of second gardening assembly apparatus 300B) with slot 306, connecting slots 306′ and 304′ of second gardening assembly apparatus, and connecting slots 304′ and 306″.

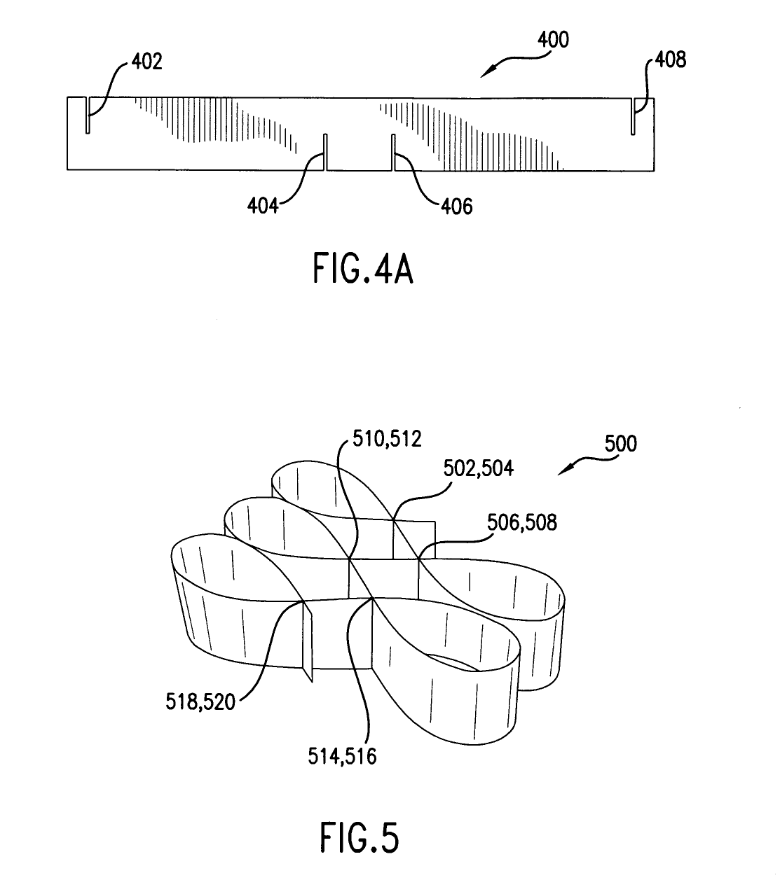

Referring now to FIG. 4A, a side view of gardening assembly apparatus 400 having four slots according to an exemplary aspect of the present invention, is shown. In this aspect, two pairs of reciprocally positioned slots are shown on the flexible sheet of material. It will be appreciated that a variety of slot configurations and arrangements are possible—whether the slot arrangements are in pairs or not.

Referring now to FIG. 5, a perspective view of a fully assembled gardening assembly 500 having multiple slots according to an exemplary aspect of the present invention, is shown. Here, gardening assembly 500 comprises of connection slots 502 through 520. This shows that the flexible sheet of material as envisioned in one aspect of the present invention, may have numerous slots on it.

In one aspect of an embodiment of the present invention, the volume of each gardening enclosure may be determined by the distance between the slots that are joined together or connected. In another aspect of an embodiment of the present invention, each gardening assembly apparatus may have a number of configurations based on the number of slots that are cut into it. By joining or connecting multiple units, in infinite number of configurations are possible. It should be noted that the connections described above are only described for exemplary purposes only as a variety of other connections other than those so described may also be possible.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as defined in the appended claims.

What is claimed is:

1. A gardening assembly apparatus, comprising:
a. a flexible sheet of material; and
b. at least one top pre-cut slot and at least one bottom pre-cut slot on said flexible sheet of material used to connect parts of said flexible sheet of material in the assembly of said gardening assembly apparatus, wherein said at least one top pre-cut slot and at least one bottom pre-cut slot are positioned at certain predetermined lengths along said flexible sheet of material and wherein each of said least one top pre-cut slot and at least one bottom pre-cut slot is half the height of said flexible sheet of material.

2. The gardening assembly apparatus according to claim 1 wherein said at least one top pre-cut slot and said at least one bottom pre-cut slot are each able to accommodate a number of pre-cut slot connections, where said number of pre-cut slot connections is determined by the ratio between the width of either of said at least one top pre-cut slot or said at least one bottom pre-cut slot and the thickness of said flexible sheet of material.

3. The gardening assembly apparatus according to claim 1, wherein said flexible sheet of material has a height in the range of 10-12 inches.

4. The gardening assembly apparatus according to claim 1, wherein said at least one top pre-cut slot and said at least one bottom pre-cut slot each is configured to connect with additional flexible sheets of material by way of the pre-cut slots of said additional flexible sheets of material.

5. The gardening assembly apparatus of according to claim 1, wherein said gardening assembly apparatus is configured to allow for water drainage.

6. The gardening assembly apparatus according to claim 1, wherein said gardening assembly apparatus is modular in design.

7. The gardening assembly apparatus according to claim 1, wherein said gardening assembly apparatus is configured for use on a variety of surfaces.

8. The gardening assembly apparatus according to claim 1, wherein said at least one top pre-cut slot and said at least one bottom pre-cut slot are positioned to create a variety of desired gardening enclosure shapes when said gardening assembly apparatus is fully assembled.

9. A gardening assembly apparatus, comprising:
a. a flexible sheet of material; and
b. at least one pair of reciprocally positioned slots used to connect parts of said flexible sheet of material in the assembly of said gardening assembly apparatus, wherein said at least one pair of reciprocally positioned slots are positioned at certain locations along said flexible sheet of material and wherein each slot of said pair is half the height of said flexible sheet of material.

10. The gardening assembly apparatus according to claim 9 wherein each slot of said pair of reciprocally positioned slots is able to accommodate a number of pre-cut slot connections, where said number of pre-cut slot connections is determined by the ratio between the width of each slot and the thickness of said flexible sheet of material.

11. The gardening assembly apparatus according to claim 9, wherein each slot of said pair of reciprocally positioned slots is configured to connect with additional flexible sheets of material by way of the slots of said additional flexible sheets of material.

12. The gardening assembly apparatus according to claim 9, wherein said at least one pair of reciprocally positioned slots are positioned to create a variety of desired gardening enclosure shapes when said gardening assembly apparatus is fully assembled.
